(19) United States
(12) Patent Application Publication
(10) Pub. No.: US 2014/0113616 A1
(43) Pub. Date: Apr. 24, 2014

(54) NETWORK INITIATED TERMINAL BACKGROUND ACTIVITY CONTROL

(71) Applicant: SONY MOBILE COMMUNICATIONS AB, Lund (SE)

(72) Inventor: Rickard Ljung, Helsingborg (SE)

(73) Assignee: Sony Mobile Communications AB, Lund (SE)

(21) Appl. No.: 13/656,222

(22) Filed: Oct. 19, 2012

(51) Int. Cl. H04W 24/00

(52) U.S. Cl. 455/419

(57) ABSTRACT

A wireless terminal configured to communicate with a network entity other than the wireless terminal in a wireless telecommunications network for the network entity to control background activities of the wireless terminal includes a receiver configured to receive a background activity policy signal including data corresponding to instructions to the wireless terminal to curtail background activities, and a background activity policy controller configured to curtail background activities of the wireless terminal based on the background activity policy signal.

### TECHNICAL FIELD OF THE INVENTION

The technology of the present disclosure relates generally to portable electronic devices and transmission equipment operable in a wireless communication network and more particularly to systems and methods for network initiated terminal background activity control.

### DESCRIPTION OF THE RELATED ART

Portable electronic devices that operate in a cellular or wireless telecommunication network, such as mobile telephones and smartphones, tablet computers, cellular-connected laptop computers, and similar devices are ever increasing in popularity. In a typical wireless telecommunication network, these devices, also known as terminals, mobile stations, and/or user equipment (UE), communicate via a radio access network (RAN) to one or more core networks. The RAN covers a geographical area which is divided into cell areas, with each cell area being served by a base station, e.g., a radio base station (RBS), which in some networks may also be called, for example, NodeB in UMTS or eNodeB in LTE. A cell is a geographical area where radio coverage is provided by the radio base station equipment at a base station site. Each cell is identified by an identity within the local radio area, which is broadcast in the cell. The base stations communicate over the air interface operating on radio frequencies with the terminals within range of the base stations.

Modern terminals run applications that may or may not be related to voice communication. Some of these applications perform activities or run services that require wireless telecommunication network communication. However, some of these activities or services are not directly initiated by the end user or may be initiated by the end user at some point but are not currently at the forefront in the terminal and thus are not currently commanding the end user's attention. These activities may be denoted as background activities. Examples of background activities include operating system updates, application software updates, weather forecast updates, social network updates, calendar synchronizations, phone book synchronizations, email synchronizations, etc.

In a network with a large amount of terminals these background activities may create high network system signaling and data traffic load. Therefore, background activities of terminals in the network may utilize a significant amount of the limited bandwidth available in the wireless telecommunications network. This bandwidth utilization by the background activities reduces the amount of bandwidth available to non-background activities such as voice communication and web browsing, which may negatively affect the quality or availability of the non-background activities. Under certain circumstances, the wireless telecommunication network may be strained to support utilization from both background and non-background terminal activities.

### SUMMARY

The concept of the systems and methods disclosed herein includes the capability for a base station or some other entity in the wireless telecommunication network other than terminals to signal terminals to effectively curtail terminal background activities. This gives network operators the ability to more effectively manage utilization of wireless telecommunications network resources.

In one aspect of the invention, a method for a network entity other than one or more terminals to control terminal background activities in a wireless telecommunications network includes the network entity encoding a background activity policy signal including data corresponding to instructions to the one or more terminals to curtail background activities of the one or more terminals, and at least one of the network entity or another network entity other than the one or more terminals transmitting the background activity policy signal to the one or more terminals.

In one embodiment, the method includes determining that background activities of the terminal are to be curtailed.

In another embodiment, the method includes determining that background activities of the terminal are to be curtailed based on at least one of a Radio Access Technology (RAT) of the network, data traffic in the network, reduced network data traffic capacity, a date, or a time of day.

In yet another embodiment, the method includes monitoring network data traffic, and determining that background activities of one or more terminals is to be curtailed based on the monitoring.

In one embodiment, the instructions to the one or more terminals to curtail background activities include at least one of: instructions to the one or more terminals to perform no background activities, or instructions to the one or more terminals to perform background activities only for a selected group of terminal applications.

In another embodiment, the transmitting includes at least one of broadcasting the policy signal to multiple terminals in the network, transmitting the policy signal individually to the one or more terminals, signaling via a Radio Resource Control (RRC) protocol connection to the one or more terminals, or signaling via a System Information Block (SIB).

In yet another embodiment, the method includes, based on the policy, storing push notifications to the one or more terminals until after a second background activity policy rescinding or modifying the policy is transmitted to the one or more terminals.

In another aspect of the invention, a method for a network entity other than a terminal to control background activities of the terminal in a wireless telecommunications network includes receiving a background activity policy signal including data corresponding to instructions to the terminal to curtail background activities, and curtailing background activities of the terminal based on the policy.

In one embodiment, the method includes monitoring whether terminal activities are background activities.

In another embodiment, the instructions to the terminal to curtail background activities include at least one of: instructions to the terminal to perform no background activities, or instructions to the terminal to perform background activities only for a selected group of terminal applications.

In yet another embodiment, the receiving includes receiving the policy signal via at least one of: a broadcast channel of the terminal, a Radio Resource Control (RRC) protocol connection, or a System Information Block (SIB).

In one embodiment, the method includes, based on the instructions, storing push notifications until a second background activity policy signal including data rescinding or modifying the instructions is received, and, after the second background activity policy signal including data rescinding or modifying the instructions is received, transmitting the stored push notifications to at least one terminal application whose background activity was previously curtailed based on the policy.

In another aspect of the invention, a network entity other than one or more terminals in a wireless telecommunications network configured to control terminal background activities includes a background activity policy encoder configured to encode a background activity policy signal including data corresponding to instructions to the one or more terminals to curtail background activities of the one or more terminals, and a transmitter configured to transmit the background activity policy signal to the one or more terminals.

In one embodiment, the background activity policy encoder is configured to determine whether data transmission in the wireless telecommunications network is to be curtailed.

In another embodiment, the network entity corresponds to a base station in a cell and the determining is made at a cell level.

In yet another embodiment, the network includes a network traffic monitor configured to monitor data traffic in the network, and the background activity policy encoder is operably connected to the network traffic monitor and configured to determine whether data transmission in the wireless telecommunications network is to be curtailed based on the data traffic in the network.

In one embodiment, the background activity policy encoder is configured to determine whether data transmission in the wireless telecommunications network is to be curtailed based on at least one of: reduced network data traffic capacity, a date, and a time of day.

In another embodiment, the instructions to the one or more terminals to curtail background activities includes at least one of instructions to the one or more terminals to perform no background activities, or instructions to the one or more terminals to perform background activities only for a selected group of terminal applications.

In yet another embodiment, the transmitter is configured to perform at least one of: broadcast the policy signal to multiple terminals in the network, transmit the policy signal individually to the one or more terminals, signal the policy signal via a Radio Resource Control (RRC) protocol connection to the one or more terminals, or signal the policy signal via a System Information Block (SIB).

In one embodiment, the network entity is configured to, based on the instructions, store push notifications to the one or more terminals until a second background activity policy rescinding or modifying the instructions is transmitted to the one or more terminals.

In another aspect of the invention, a wireless terminal configured to communicate with a network entity other than the wireless terminal in a wireless telecommunications network for the network entity to control background activities of the wireless terminal includes a receiver configured to receive a background activity policy signal including data corresponding to instructions to the wireless terminal to curtail background activities, and a background activity policy controller configured to curtail background activities of the wireless terminal based on the background activity policy signal.

In one embodiment, the terminal includes a background activity monitor configured to monitor whether wireless terminal activities are background activities, and the background activity policy controller is configured to limit wireless transmission of data from the background activities.

In another embodiment, based on the instructions to the wireless terminal to curtail background activities, the background activity policy controller curtails at least one of: all wireless data transmissions corresponding to the background activities, or wireless data transmissions corresponding to a selected group of terminal applications performing background activities.

In yet another embodiment, the receiver is configured to receive the background activity policy signal via at least one of: a broadcast channel, a Radio Resource Control (RRC) protocol connection, or a System Information Block (SIB).

In one embodiment, the background activity policy controller is configured to, based on the instructions, store push notifications until a second background activity policy signal including data rescinding or modifying the instructions is received, and after the second background activity policy signal including data rescinding or modifying the instructions is received, transmit the stored push notifications to at least one terminal application whose background activity was previously curtailed based on the instructions.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto.

Features that are described and/or illustrated with respect to one embodiment may be used in the same way or in a similar way in one or more other embodiments and/or in combination with or instead of the features of the other embodiments.

It should be emphasized that the terms “comprises” and “comprising,” when used in this specification, are taken to specify the presence of stated features, integers, steps or components but do not preclude the presence or addition of one or more other features, integers, steps, components or groups thereof.

### BRIEF DESCRIPTION OF THE DRAWINGS

FIG. 1 illustrates a portion of a wireless telecommunications network.

FIG. 2 illustrates a simplified block diagram of an exemplary terminal in a wireless telecommunication network.

FIG. 3 illustrates a schematic diagram of a radio access network including exemplary block diagrams of a terminal and a base station in the network.

FIG. 4 illustrates a logical flow of a method for a network entity other than one or more terminals to control terminal background activities in a wireless telecommunications network.

FIG. 5 illustrates a logical flow of a method for a network entity other than a terminal to control background activities of the terminal in a wireless telecommunications network.

FIG. 6 illustrates a detailed block diagram of an exemplary terminal, which in the illustrated embodiment is represented by a mobile phone.

### DETAILED DESCRIPTION OF EMBODIMENTS

Embodiments of the present invention will now be described with reference to the drawings, wherein like reference numerals are used to refer to like elements throughout. It will be understood that the figures are not necessarily to scale.

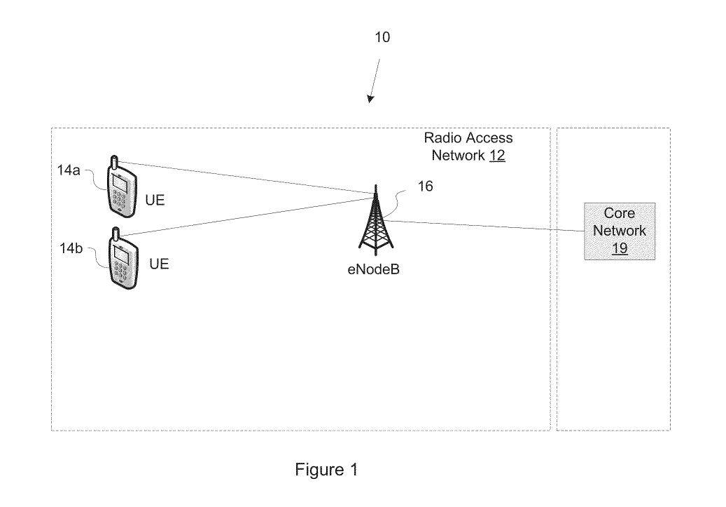

FIG. 1 illustrates a portion of a wireless telecommunications network 10. The network 10 includes a radio access network (RAN) 12. FIG. 1 illustrates the RAN 12 as an Evolved Universal Terrestrial Radio Access Network (EUTRAN), the RAN associated with LTE, as an example. However, the RAN 12 may also be any RAN other than EUTRAN including RAN that are currently deployed as well as RAN that are currently in development or that will be developed in the future. The network 10 includes a core network 19, which includes the parts of the telecommunications network 10 that provide the various services to customers who are connected by the RAN 12.

The RAN 12 includes terminals 14a-b. The terminals 14a-b are what in LTE is referred to as user equipment (UE). In wireless telecommunications networks other than LTE, including networks that are currently deployed as well as networks that are currently in development or that will be developed in the future, the terminals may be referred to by terms other than terminals, mobile stations, or user equipment. However, the term terminals as employed herein is intended to include those terminals in wireless telecommunications networks such as UMTS and LTE as well as networks other than UMTS and LTE, and terminals in yet to be developed or deployed networks where the terminals have similar functionality as the terminals described herein in the context of LTE.

The RAN 12 further includes a base station 16. As discussed above, in LTE the base station 16 is known as eNodeB (evolved NodeB or eNB). In wireless telecommunications networks other than LTE, including networks that are currently deployed as well as networks that are currently in development or that will be developed in the future, the base stations may be referred to by terms other than base stations, NodeB, or eNodeB. However, the term base station as employed herein is intended to include those base stations in wireless telecommunications networks such as UMTS and LTE as well as networks other than UMTS and LTE, and base stations in yet to be developed or deployed networks where the base stations have similar functionality as the base stations described herein in the context of LTE. Moreover, a base station as the term is employed herein may include other entities in wireless telecommunications systems that control the uplink transmissions of the terminals in a similar manner as the base stations disclosed herein. For example, a relay node that may be made to control the uplink transmissions of the terminals behaves as a base station.

The base station 16 communicates with the terminals 14a-b using radio access technologies (RAT) via an air interface. In LTE the RAT is known as LTE and the air interface is known as LTE-Uu. Although RAN 12 has been described as discreetly LTE, in practice, base stations may be multi radio units, capable of transmitting in several different RAT. Due to the reuse of infrastructure at the cellular sites, as well as backhaul capabilities, a single base station may be using more than one RAT and may be transmitting at more than one carrier frequency.

In a network 10 with a large amount of terminals 14 background activities of the terminals 14 may create high network signaling and data traffic load. The background activities of the terminals 14 may utilize a significant amount of the limited bandwidth resources available in the wireless telecommunications network. As discussed above, this bandwidth utilization by the background activities reduces the amount of bandwidth available to non-background activities such as voice communication, which may negatively affect the quality or availability of the non-background activities.

A characteristic of background activities is that they do not need to occur at a specific time. For example, software updates typically do not need to occur right away, but may wait until an opportune time for the update to take place. Therefore, background activities are to varying extents delay-tolerant as to when transmission via the wireless telecommunication network 10 need to take place. This is unlike non-background activities such as, for example, voice communication or web browsing, where significant delay in wireless telecommunications network communication is intolerable or would make the user experience unsatisfactory.

In one embodiment, the base station 16 signals to the terminals 14a and 14b policies for utilization of resources of the wireless telecommunications network 10 by background activities. Based on the received policy signal set by the network, the terminals 14a and 14b curtail terminal background activities.

In one embodiment, background activity policy set by the network is determined at a cell level. In one example, cells in the network may have load situations that vary from cell to cell. In this case, a first policy applied to a first cell will likely be different from a second policy applied to a second cell with a different load situation from that of the first cell.

In another embodiment, background activity policy set by the network is determined at a terminal level. In one example, a particular terminal may be determined by the network to have very high network utilization. In this case, a terminal specific policy may be applied to the very active terminal in an attempt to reduce the terminal's network utilization.

In another embodiment, network policy may alternatively or additionally be determined based on the day of the week, the time of day, or the measured network or cell load. For example, a first cell in a network may be located in a congested location (e.g., city center) while a second cell may be located in a less congested location (e.g., suburb). The network may curtail terminal utilization of network resources in the first cell based on the time of day or traffic load in the first cell, while the network may allow full around-the-clock utilization of network resources by terminals in the second less-congested cell.

In another embodiment, background activity policy set by the network is determined based on what network or RAT the terminal 14a or 14b is using. For example, a policy may be established that allows for full network utilization by the terminals 14a and 14b when the terminals operate in LTE. At the same time the policy may curtail network utilization by background activities of the terminals 14a and 14b when the terminals operate in UMTS. It may be that in the above example a determination has been made that the LTE network can tolerate the additional traffic load while the UMTS network cannot.

When the base station 16 or another entity in the network other than the terminals 14a or 14b determines that terminal background activity needs curtailed, the base station 16 signals a background activity policy signal to the terminal 14a or 14b. The policy signal includes instructions to the terminals 14a or 14b to curtail background activities. The terminal 14a or 14b receiving the background activity policy signal, in turn, instructs application running in the terminal 14a or 14b to curtail background activities.

Similarly, as the base station 16, or another entity in the network other than the terminals 14a or 14b, determines that background activities no longer need curtailed, the base station 16 signals a background activity policy signal to the terminal 14a or 14b. The policy signal includes instructions to the terminals 14a or 14b that background activities no longer need curtailed. The terminals, in turn, instruct applications to cease curtailing background activities (i.e., background activities are allowed to use network transmission resources).

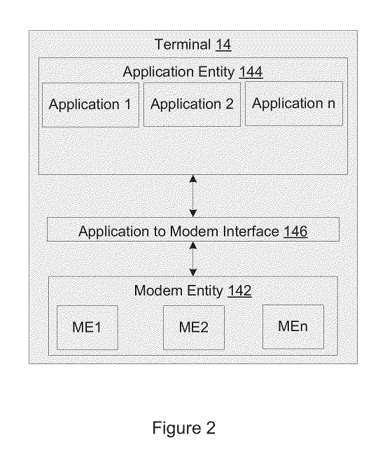

FIG. 2 illustrates a simplified block diagram of an exemplary terminal 14 in a wireless telecommunication network. The terminal 14 includes a modem entity 142 and an application entity 144. The application entity 144 comprises one or more applications or programs (Application 1, Application 2 . . . , Application n) that run on an operating system of the terminal 14. The application entity 144 utilizes the modem entity 142 for connectivity to the wireless telecommunication network. The modem entity 142 handles communication with the base station 16 in the wireless telecommunication network 10 and is responsible for the radio protocols. The modem entity 142 may include one or more modules (ME1, ME2 . . . , MEn). Each module may have the capability of accessing a wireless telecommunication network using a different type of RAT. For example, ME1 may access the wireless telecommunication network using LTE while ME2 may access the wireless telecommunication network using UMTS. The terminal 14 further includes an application-to-modem interface 146 that provides a connection between the application entity 144 and the modem entity 142.

The application entity 144 is responsible for most functionality relating to end user interaction including input/output for end user interface and the handling of all end user initiated applications including voice call, internet access, music/video playback, gaming, etc. as well as the handling of background activities. When an application requires wireless network communication, the application entity 144 requests access to the network from the modem entity 142 via the application-to-modem interface 146. The modem entity 142 handles the communication with the network via the base station 16.

As discussed above, the applications typically perform a significant amount of background activities. Based on some criteria, the network operator may wish to curtail terminal background activities by signaling a policy signal to the terminal 14. The modem entity 142 receives the policy signal via the wireless telecommunications network 10. The modem entity 142 forwards the policy over the application-to-modem interface 146 to the application entity 144. The application entity 146 receives the policy and distributes access rights to the applications.

As discussed above, background activity policy may be determined based on what network or RAT the terminal 14 is using. In one embodiment, a policy may be that terminal applications may utilize the ME1, which operates in a first RAT (e.g., LTE) to run background activities. At the same time the policy may dictate that the terminal applications may not utilize the ME2, which operates in a second RAT (e.g., UMTS) to run background activities. It may be that in the above example a determination was made that the LTE network could tolerate the load caused by the background activities while the UMTS network could not.

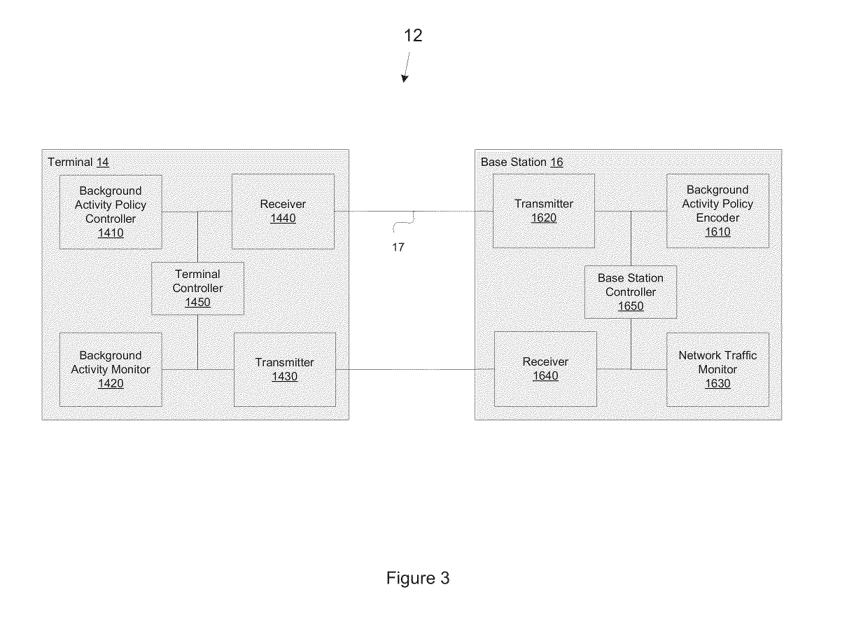

FIG. 3 illustrates a schematic diagram of the RAN 12 including exemplary block diagrams of the terminal 14 and the base station 16.

The base station 16 includes a background activity policy encoder 1610 that encodes a background activity policy signal 17 that includes instructions to the terminal 14 to curtail background activities of the terminal 14. The base station 16 further includes a transmitter 1620 that transmits the background activity policy signal 17 to the terminal 14.

In one embodiment, the background activity policy encoder 1610 determines whether background activities of the terminal 14 are to be curtailed. Where the background activity policy encoder 1610 makes the determination that background activities are to be curtailed, the encoder 1610 encodes the background activity policy signal 17 instructing the terminal 14 (and in some cases other terminals in the network) to curtail background activities.

In one embodiment, the background activity policy encoder 1610 determines whether data transmission in the networks 10 or 12 is to be curtailed based on reduced network data traffic capacity (e.g., partial network failure, network repairs, etc.), date (e.g., holiday such as mother's day), day of the week (e.g., weekday versus weekend day), or the time of the day (e.g., peak hours for voice communication).

In some embodiments, the background activity policy encoder 1610 determines that background activities are to be curtailed for multiple terminals in the network. In one embodiment, the background activity policy encoder 1610 determines that background activities are to be curtailed at the terminal level or for multiple terminals in the network based on information that the encoder 1610 receives from other network entities.

In one embodiment, the base station 16 includes a traffic monitor 1630 that monitors data traffic.

In one embodiment the traffic monitor 1630 monitors data traffic in the network 12. In this embodiment, the background activity policy encoder 1610 receives data traffic information from the traffic monitor 1630 and determines whether data transmission in the network 12 is to be curtailed based on the data traffic information. Curtailing of data transmission in the network 12 may include the curtailing of background activities of terminals 14 in the network 12. Since the terminal background activities to be curtailed in this case are network-wide, the transmitter 1620 may broadcast the policy signal to all of the terminals connected to the base station 16. In the alternative, the transmitter 1620 may transmit the policy signal individually to each terminal 14.

In another embodiment, the traffic monitor 1630 monitors data traffic of individual terminals 14. In this embodiment, the background activity policy encoder 1610 receives data traffic information from the traffic monitor 1630 and determines whether data transmission of a specific terminal 14 is to be curtailed based on the data traffic information. Since the terminal background activity to be curtailed in this case is for a particular terminal, the transmitter 1620 transmits the policy signal individually to each terminal 14.

In other embodiments, the traffic monitor 1630 monitors data traffic at the base station 16 level, or at a cell level, or at some other level in the wider network 10. In these embodiments, the background activity policy encoder 1610 receives data traffic information from the traffic monitor 1630 and determines whether data transmission of the level is to be curtailed based on the data traffic information.

In one embodiment, where the base station 16 is aware that current policy to the terminal 14 is to curtail background activities, the base station 16 stores push notifications intended for the terminal 14 until current background activity policy is changed or until the base station 16 transmits a new policy signal 17 rescinding or modifying the policy instructions.

The base station 16 further includes a receiver 1640 for receiving communications from the terminal 14 and a base station controller 1650 operatively connected to the background activity policy encoder 1610, the transmitter 1620, the network traffic monitor 1630, and the receiver 1640 to thereby control the base station 16.

In the embodiment of FIG. 3 the various attributes regarding background activity policy setting and control are discussed in the context of the base station 16 for ease of explanation. However, the background activity policy setting and control may reside in any network entity other than the terminal 14. The various attributes discussed above as included in the base station 16 may reside at the core network 19 of FIG. 1 or the various attributes may be distributed among various entities in the network 10. For example, the network traffic monitor 1630 may reside, for example, at the core network 19 while the background activity policy encoder 1610 may reside at the base station 16. Moreover, a policy generating function block (not shown) may be implemented at the core network 19 to generate or store system-wide policies regarding background activities. Implementation of this policy generating function block may reside at an existing core network node (e.g., the core network's Home Location Register (HLR)) or at a new separate control node within the core network 19.

The terminal 14 includes a receiver 1440 that receives the background activity policy signal 17 that includes instructions to the terminal 14 to curtail background activities. The terminal 14 further includes a background activity policy controller 1410 that curtails background activities of the wireless terminal 14 based on the instructions to the wireless terminal 14 in the policy signal 17 to curtail background activities.

In one embodiment, the terminal 14 includes a background activity monitor 1420 that determines whether wireless terminal activities are background activities. Based on a determination by the background activity monitor 1420 that a wireless terminal activity seeking access to the network 12 is a background activity, the background activity policy controller 1410 denies the terminal activity access to the network 12 when current policy curtails background activities to limit wireless transmission of data from background activities.

In one embodiment, where current policy to the terminal 14 is to curtail background activities, the background activity policy controller 1410 causes incoming push notifications to be stored in the terminal 14 and not transmitted to terminal applications that would attempt to perform background activities in response to the push notifications. When current policy is modified or rescinded by a new policy signal, the background activity policy controller 1410 causes the stored push notifications to be transmitted to corresponding terminal applications.

As discussed above, in some embodiments, the transmitter 1620 broadcasts the policy signal to all of the terminals connected to the base station 16, while in other embodiments, the transmitter 1620 transmits the policy signal individually to each terminal 14.

For embodiments where the transmitter 1620 broadcasts the policy signal, the RAT standard (e.g., 3GPP standard for WCDMA or LTE) may include an application policy signal into a broadcasted system information block (SIB) or similar block. SIB are broadcasted by the base station 16 and are received by all of the terminals 14 within the base station's coverage. SIB are mapped to the broadcast channel (BCH) and are described by 3GPP in TS 25.331 for WCDMA and 36.331 for LTE. In addition to the SIB currently specified in the 3GPP standards signaling, a system information block may be defined for broadcasting policy signals including information regarding the policy for background activities. The SIB signal may then be modified at any time to update to current policy.

For embodiments where the transmitter 1620 transmits the policy signal on an individual terminal basis, the RAT standard (e.g., 3GPP standard for WCDMA or LTE) may include a policy signal within, for example, the Radio Resource Control (RRC) configuration. In this manner the network 12 is able to control the background activities policy in a terminal per terminal basis, and the policy may also be updated for an individual terminal by the initiation of an RRC reconfiguration. The RRC specifications are described by 3GPP in TS 25.331 for WCDMA and 36.331 for LTE.

Specific policy levels signaled by the base station 16 to the terminal 14 may be signaled in a range (e.g., 2-3 bits that give 4-8 policy levels) and could range from no background activities allowed at all, to intermediate steps where background activities are curtailed but allowed for, for example, a set number of activities per unit time (e.g., one push every 10 minutes), to fully allowed. In another embodiment, the policy signal 17 includes instructions to the terminal 14 to selectively allow background activities for a selected group of terminal applications or to selectively allow a selected group of activities.

The terminal 14 further includes a transmitter 1430 that connects to the base station receiver 1640 and a terminal controller 1450 operatively connected to the background activity policy controller 1410, the background activity monitor 1420, the transmitter 1430, and the receiver 1440 to thereby control the terminal 14.

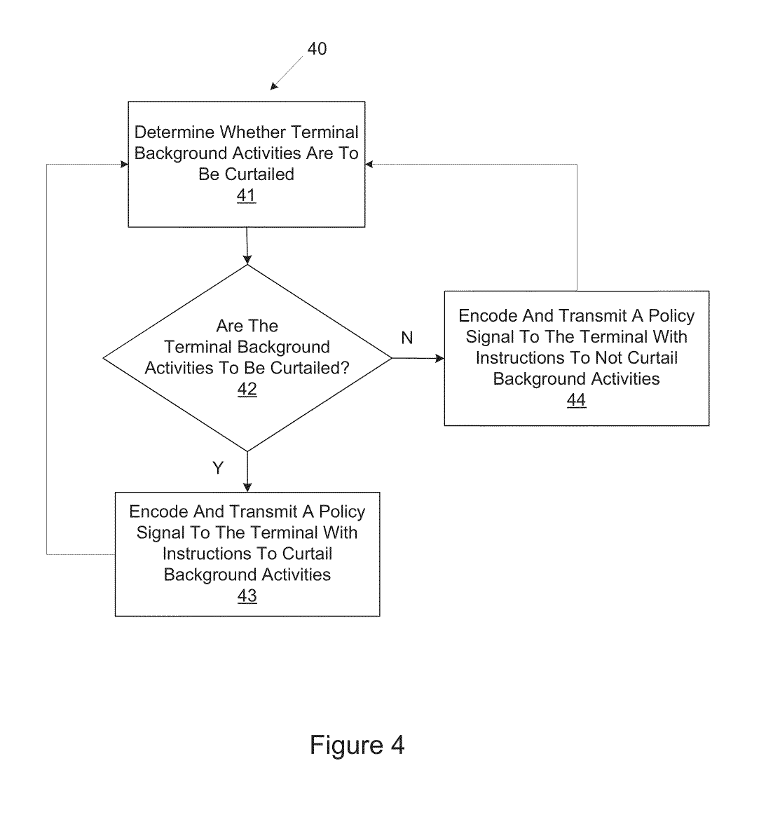

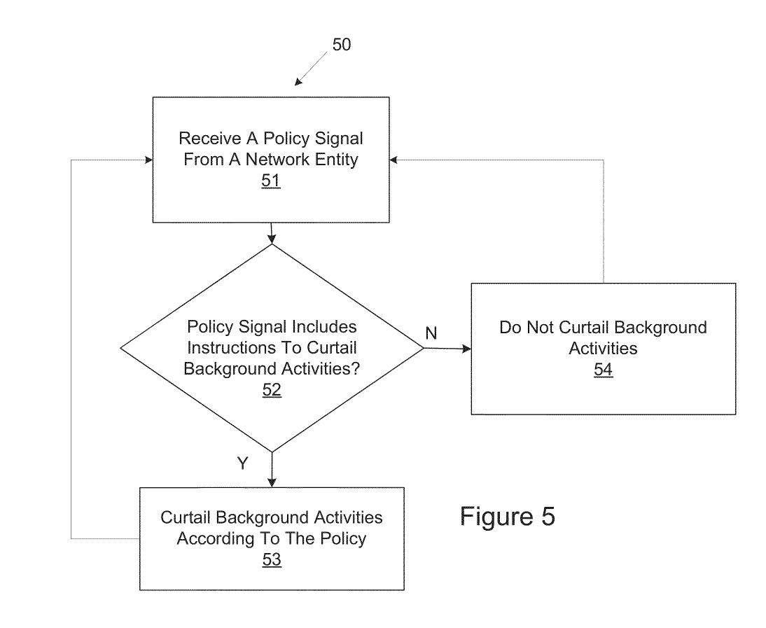

In accordance with the above features, FIGS. 4 and 5 show flowcharts that illustrate logical operations to implement exemplary methods for network initiated terminal background activities control. The exemplary methods may be carried out by executing embodiments of the base stations, terminals, mobile telephones, flash devices or machine-readable storage media disclosed herein, for example. Thus, the flowcharts of FIGS. 4 and 5 may be thought of as depicting steps of a method carried out in the above-disclosed systems or devices by operation of hardware, software, or combinations thereof. Although FIGS. 4 and 5 show a specific order of executing functional logic blocks, the order of executing the blocks may be changed relative to the order shown. Also, two or more blocks shown in succession may be executed concurrently or with partial concurrence. Certain blocks also may be omitted.

In reference to FIG. 4, logical flow of a method 40 for a network entity other than one or more terminals to control terminal background activities in a wireless telecommunications network includes, at 41, determining whether background activities of the terminal are to be curtailed. At 42, if the background activities of the terminal are to be curtailed, at 43, encoding and transmitting a background activity policy signal to the terminal with instructions to curtail background activities and return to 41 to determining whether background activities of the terminal are to be curtailed. Back to 42, if the background activities of the terminal are not to be curtailed, at 44, the method 40 includes, encoding and transmitting a background activity policy signal to the terminal with instructions to not curtail background activities and return to 41. In one embodiment, the determining that background activities of the terminal are to be curtailed is based on at least one of a Radio Access Technology (RAT) of the network, data traffic in the network, reduced network data traffic capacity, the date, and the time of the day.

In one embodiment, the method 40 further includes monitoring network data traffic, and determining that background activities of one or more terminals are to be curtailed based on the monitoring. In one embodiment, the method 40 further includes, based on the policy instructions, storing push notifications to the one or more terminals until after a second background activity policy rescinding or modifying the instructions is transmitted to the one or more terminals.

In reference to FIG. 5, logical flow of a method 50 for method for a network entity other than a terminal to control background activities of the terminal in a wireless telecommunications network is shown. At 51, the method 50 includes receiving a background activity policy signal. At 52, if the policy signal includes data corresponding to instructions to the terminal to curtail background activities, at 53, curtail background activities of the terminal based on the policy, and, return to 51. Back to 52, if the policy signal includes data corresponding to instructions to the terminal not to curtail background activities, at 54, do not curtail background activities of the terminal and return to 51.

In one embodiment, the method 50 includes monitoring whether terminal activities are background activities, and if so, limiting wireless transmission of data from the background activities. In one embodiment, the method 50 includes, based on the instructions, storing push notifications until a second background activity policy signal including data rescinding or modifying the instructions is received, and after the second background activity policy signal including data rescinding or modifying the instructions is received, transmitting the stored push notifications to at least one terminal application whose background activity was previously curtailed based on the policy.

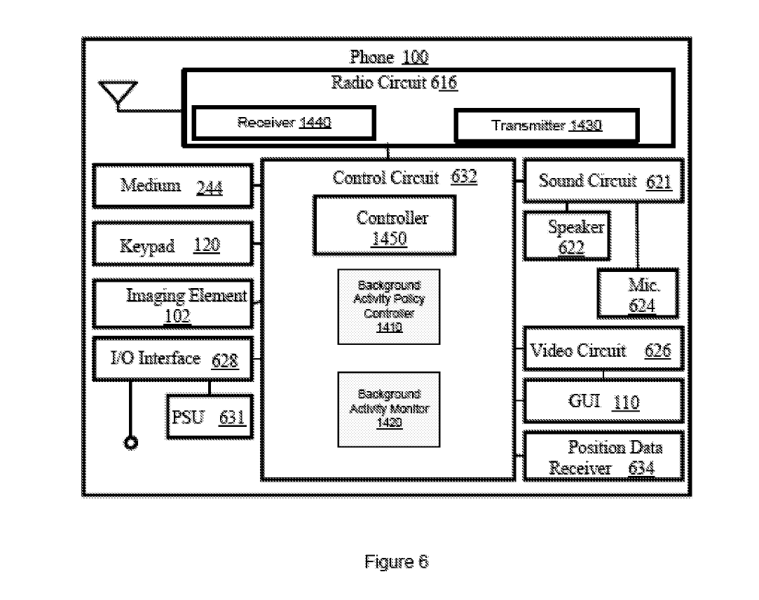

FIG. 6 illustrates a detailed block diagram of an exemplary terminal, which in the illustrated embodiment is represented by the mobile phone 100. The phone 100 includes a control circuit 632 that is responsible for overall operation of the phone 100. For this purpose, the control circuit 632 includes the terminal controller 1450 that executes various applications, including applications related to or that form part of the phone 100 functioning as a terminal.

In one embodiment, functionality of the phone 100 acting as the terminal described above in reference to FIGS. 1-5 are embodied in the form of executable logic (e.g., lines of code, software, or a program) that is stored in the non-transitory computer readable medium 244 (e.g., a memory, a hard drive, etc.) of the phone 100 and is executed by the control circuit 632. The described operations may be thought of as a method that is carried out by the phone 100. Variations to the illustrated and described techniques are possible and, therefore, the disclosed embodiments should not be considered the only manner of carrying out phone 100 functions.

The phone 100 further includes the GUI 110, which may be coupled to the control circuit 632 by a video circuit 626 that converts video data to a video signal used to drive the GUI 110. The video circuit 626 may include any appropriate buffers, decoders, video data processors and so forth.

The phone 100 further includes communications circuitry that enables the phone 100 to establish communication connections such as a telephone call. In the exemplary embodiment, the communications circuitry includes a radio circuit 616. The radio circuit 616 includes one or more radio frequency transceivers including the receiver 1440, the transmitter 1430 and an antenna assembly (or assemblies). Since the phone 100 is capable of communicating using more than one standard, the radio circuit 616 including the receiver 1440 and the transmitter 1430 represents each radio transceiver and antenna needed for the various supported connection types. The radio circuit 616 including the receiver 1440 and the transmitter 1430 further represents any radio transceivers and antennas used for local wireless communications directly with an electronic device, such as over a Bluetooth interface.

As indicated, the phone 100 includes the primary control circuit 632 that is configured to carry out overall control of the functions and operations of the phone 100. The terminal controller 1450 of the control circuit 632 may be a central processing unit (CPU), microcontroller or microprocessor. The terminal controller 1450 executes code stored in a memory (not shown) within the control circuit 632 and/or in a separate memory, such as the machine-readable storage medium 244, in order to carry out operation of the phone 100. The machine-readable storage medium 244 may be, for example, one or more of a buffer, a flash memory, a hard drive, a removable media, a volatile memory, a non-volatile memory, a random access memory (RAM), or other suitable device. In a typical arrangement, the machine-readable storage medium 244 includes a non-volatile memory for long term data storage and a volatile memory that functions as system memory for the control circuit 632. The machine-readable storage medium 244 may exchange data with the control circuit 632 over a data bus. Accompanying control lines and an address bus between the machine-readable storage medium 244 and the control circuit 632 also may be present. The machine-readable storage medium 244 is considered a non-transitory computer readable medium. In one embodiment, data regarding the indication is stored in the machine-readable storage medium 244. Within the primary control circuit 632 are the background activity policy controller 1410 and the background activity monitor 1420.

The phone 100 may further include a sound circuit 621 for processing audio signals. Coupled to the sound circuit 621 are a speaker 622 and a microphone 624 that enable a user to listen and speak via the phone 100, and hear sounds generated in connection with other functions of the device 100. The sound circuit 621 may include any appropriate buffers, encoders, decoders, amplifiers and so forth.

The phone 100 may further include a keypad 120 that provides for a variety of user input operations as described above in reference to FIG. 1. The phone 100 may further include one or more input/output (I/O) interface(s) 628. The I/O interface(s) 628 may be in the form of typical electronic device I/O interfaces and may include one or more electrical connectors for operatively connecting the phone 100 to another device (e.g., a computer) or an accessory (e.g., a personal handsfree (PHF) device) via a cable. Further, operating power may be received over the I/O interface(s) 628 and power to charge a battery of a power supply unit (PSU) 631 within the phone 100 may be received over the I/O interface(s) 628. The PSU 631 may supply power to operate the phone 100 in the absence of an external power source.

The phone 100 also may include various other components. For instance, the imaging element 102 may be present for taking digital pictures and/or movies. Image and/or video files corresponding to the pictures and/or movies may be stored in the machine-readable storage medium 244. As another example, a position data receiver 634, such as a global positioning system (GPS) receiver, may be present to assist in determining the location of the phone 100.

Although the invention has been shown and described with respect to certain preferred embodiments, it is understood that equivalents and modifications will occur to others skilled in the art upon the reading and understanding of the specification. The present invention includes all such equivalents and modifications, and is limited only by the scope of the following claims.

1. A method for a network entity other than one or more terminals to control terminal background activities in a wireless telecommunications network, the method comprising:
the network entity encoding a background activity policy signal including data corresponding to instructions to the one or more terminals to curtail background activities of the one or more terminals; and
at least one of the network entity or another network entity other than the one or more terminals transmitting the background activity policy signal to the one or more terminals.

2. The method of claim 1, comprising:
determining that background activities of the terminal are to be curtailed.

3. The method of claim 1, comprising:
determining that background activities of the terminal are to be curtailed based on at least one of:
a Radio Access Technology (RAT) of the network,
data traffic in the network,
reduced network data traffic capacity,
date, and
time of day.

4. The method of claim 1, comprising:
monitoring network data traffic; and
determining that background activities of one or more terminals are to be curtailed based on the monitoring.

5. The method of claim 1, wherein the instructions to the one or more terminals to curtail background activities includes at least one of:
instructions to the one or more terminals to perform no background activities, or
instructions to the one or more terminals to perform background activities only for a selected group of terminal applications.

6. The method of claim 1, wherein the transmitting includes at least one of:
broadcasting the policy signal to multiple terminals in the network,
transmitting the policy signal individually to the one or more terminals,
signaling via a Radio Resource Control (RRC) protocol connection to the one or more terminals, or
signaling via a System Information Block (SIB).

7. The method of claim 1, comprising:
based on the instructions, storing push notifications to the one or more terminals until after a second background activity policy rescinding or modifying the instructions is transmitted to the one or more terminals.

8. A method for a network entity other than a terminal to control background activities of the terminal in a wireless telecommunications network, the method comprising:
receiving a background activity policy signal including data corresponding to instructions to the terminal to curtail background activities; and
curtailing background activities of the terminal based on the policy.

9. The method of claim 8, comprising:
monitoring whether terminal activities are background activities; and
wherein the curtailing includes limiting wireless transmission of data from the background activities.

10. The method of claim 8, wherein the instructions to the terminal to curtail background activities includes at least one of:
instructions to the terminal to perform no background activities, or
instructions to the terminal to perform background activities only for a selected group of terminal applications.

11. The method of claim 8, wherein the receiving includes receiving the policy signal via at least one of:
a broadcast channel of the terminal,
a Radio Resource Control (RRC) protocol connection, or
a System Information Block (SIB).

12. The method of claim 8, comprising:
based on the instructions, storing push notifications until a second background activity policy signal including data rescinding or modifying the instructions is received, and
after the second background activity policy signal including data rescinding or modifying the instructions is received, transmitting the stored push notifications to at least one terminal application whose background activity was previously curtailed based on the policy.

13. A network entity other than one or more terminals in a wireless telecommunications network configured to control terminal background activities, the network entity comprising:
a background activity policy encoder configured to encode a background activity policy signal including data corresponding to instructions to the one or more terminals to curtail background activities of the one or more terminals; and
a transmitter configured to transmit the background activity policy signal to the one or more terminals.

14. The network entity of claim 13, wherein the background activity policy encoder is configured to determine whether data transmission in the wireless telecommunications network is to be curtailed.

15. The network entity of claim 13, wherein the network entity corresponds to a base station in a cell and the determining is made at a cell level.

16. The network entity of claim 13, comprising:
a network traffic monitor configured to monitor data traffic in the network, and
wherein the background activity policy encoder is operably connected to the network traffic monitor and configured to determine whether data transmission in the wireless telecommunications network is to be curtailed based on the data traffic in the network.

17. The network entity of claim 13, wherein the background activity policy encoder is configured to determine whether data transmission in the wireless telecommunications network is to be curtailed based on at least one of:
reduced network data traffic capacity,
date, and
time of day.

18. The network entity of claim 13, wherein the instructions to the one or more terminals to curtail background activities includes at least one of:
instructions to the one or more terminals to perform no background activities, or
instructions to the one or more terminals to perform background activities only for a selected group of terminal applications.

19. The network entity of claim 13, wherein the transmitter is configured to perform at least one of:
broadcast the policy signal to multiple terminals in the network,
transmit the policy signal individually to the one or more terminals,
signal the policy signal via a Radio Resource Control (RRC) protocol connection to the one or more terminals, or
signal the policy signal via a System Information Block (SIB).

20. The network entity of claim 13, wherein the network entity is configured to, based on the instructions, store push notifications to the one or more terminals until a second background activity policy rescinding or modifying the instructions is transmitted to the one or more terminals.

21. A wireless terminal configured to communicate with a network entity other than the wireless terminal in a wireless telecommunications network for the network entity to control background activities of the wireless terminal, the wireless terminal comprising:
a receiver configured to receive a background activity policy signal including data corresponding to instructions to the wireless terminal to curtail background activities; and
a background activity policy controller configured to curtail background activities of the wireless terminal based on the background activity policy signal.

22. The wireless terminal of claim 21, comprising:
a background activity monitor configured to monitor whether wireless terminal activities are background activities; and
wherein the background activity policy controller is configured to limit wireless transmission of data from the background activities.

23. The wireless terminal of claim 21, wherein, based on the instructions to the wireless terminal to curtail background activities, the background activity policy controller curtails at least one of:
all wireless data transmissions corresponding to the background activities, or
wireless data transmissions corresponding to a selected group of terminal applications performing background activities.

24. The wireless terminal of claim 21, wherein the receiver is configured to receive the background activity policy signal via at least one of:
a broadcast channel,
a Radio Resource Control (RRC) protocol connection, or
a System Information Block (SIB).

25. The wireless terminal of claim 21, wherein the background activity policy controller is configured to, based on the instructions, store push notifications until a second background activity policy signal including data rescinding or modifying the instructions is received, and after the second background activity policy signal including data rescinding or modifying the instructions is received, transmit the stored push notifications to at least one terminal application whose background activity was previously curtailed based on the instructions.
